(19) United States
(12) Patent Application Publication
(10) Pub. No.: US 2026/0042638 A1
(43) Pub. Date: Feb. 12, 2026

(54) ELEVATOR SYSTEM AND METHODS OF INSTALLING AND DEINSTALLING A MOBILE WORKING PLATFORM IN AN ELEVATOR SYSTEM

(71) Applicant: Otis Elevator Company, Farmington, CT (US)

(72) Inventor: Pascal Rebillard, Gien (FR)

(21) Appl. No.: 19/289,554

(22) Filed: Aug. 4, 2025

(30) Foreign Application Priority Data
Aug. 6, 2024 (EP) 24306328.6

(51) Int. Cl. B66B 5/00; A47B 67/04; A47B 81/00; E04G 1/34

(52) U.S. Cl. CPC B66B 5/0087; A47B 67/04; A47B 81/00; E04G 1/34

(57) ABSTRACT

An elevator system (2) includes a hoistway (4) extending between a plurality of landings (8) and an elevator car (6) that is movable in the hoistway (4) between the plurality of landings (8); landing doors (10) provided at the landings (8); and at least one storage cavity (30) provided at at least one of the landings (8) for accommodating a mobile working platform (50), that is configured to be set up in the elevator car (6). The at least one storage cavity (30) is formed in a wall (24) of the hoistway (4) and/or in a landing door frame (26) provided at the respective landing (8).

### FOREIGN PRIORITY

This application claims priority to European Patent Application No. 24306328.6, filed Aug. 6, 2024, and all the benefits accruing therefrom under 35 U.S.C. § 119, the contents of which in its entirety are herein incorporated by reference.

### TECHNICAL FIELD OF INVENTION

The invention relates to an elevator system comprising a storage space for a mobile working platform. The invention further relates to a method of installing a mobile working platform in an elevator system and to a method of deinstalling a mobile working platform in an elevator system.

### BACKGROUND OF THE INVENTION

An elevator system typically comprises at least one elevator car configured for moving along a hoistway extending between a plurality of landings.

For inspection, repair and/or maintenance, a person, in particular a mechanic, may need to access components located on top of the elevator car or in the hoistway above the elevator car.

It may be beneficial to provide a tool that facilitates accessing components on top of the elevator car or in the hoistway above the elevator car without permanently reducing the space that is available for passengers in the elevator car.

### SUMMARY OF THE INVENTION

According to an exemplary embodiment of the invention, an elevator system comprises a hoistway extending between a plurality of landings and an elevator car that is movable in the hoistway between the plurality of landings. The elevator system further comprises a plurality of landing doors provided at the landings and allowing passengers to transfer between the elevator car and the respective landing. At least one storage cavity is provided at at least one of the landings for accommodating a mobile working platform. The mobile working platform is configured to be set up in the elevator car in order to allow a person, in particular a mechanic, to access components located on top of the elevator car or in the hoistway above the elevator car. The at least one storage cavity is formed in a wall of the hoistway and/or in a landing door frame provided at the respective landing.

Exemplary embodiments of the invention allow for storing a mobile working platform close to the elevator car without reducing the space that is available for passengers in the elevator car. According to exemplary embodiments of the invention, the platform is easily accessible to a person, in particular to a mechanic, who likes to use the mobile working platform for accessing components located on top of the elevator car or in the hoistway above the elevator car. As a result, the person may conveniently access components on top of the elevator car or in the hoistway above the elevator car without carrying a platform, a ladder or a similar device to the elevator system. In consequence, inspection, maintenance and repair of the elevator system may be facilitated and performed faster and more conveniently.

In the following, a number of optional features of an elevator system according to exemplary embodiments of the invention are set out. These features may be realized in particular embodiments, alone or in combination with any of the other features, unless explicitly stated otherwise.

The elevator system may comprise at least one drawer that is movable in and out of the at least one cavity. The at least one drawer may in particular be pivotable or linearly movable in and out of the at least one cavity. Providing such a drawer may allow for moving the mobile working platform even more easily in and out of the storage cavity.

The at least one drawer may be made of metal and/or of a synthetic material.

The at least one drawer may comprise at least one closable box for accommodating the mobile working platform. The at least one closable box may be made of metal and/or of a synthetic material.

Storing the mobile working platform in a closable box may protect the mobile working platform from adverse external influences, such as dirt and/or moisture. It may further prevent the platform from getting caught when moved in and out of the at least one cavity.

The elevator system may comprise a motor that is configured for moving the drawer in and out of the at least one cavity by operating the motor. Employing a motor for moving the drawer in and out of the at least one cavity may result in a very convenient access to the mobile working platform.

Alternatively or additionally, the at least one drawer may be manually movable in and out of the at least one cavity. Moving the drawer manually is very reliable and allows implementing an elevator system according to an exemplary embodiment of the invention at relatively low costs.

The drawer may be movable in a plane that is oriented perpendicularly to the moving direction of the landing door provided at the respective landing.

In an alternative embodiment, the drawer may be movable in a plane that is oriented parallel to the moving direction of the landing door provided at the respective landing.

The preferable moving direction of the drawer may depend on the specific geometry of the elevator system, in particular on the geometry at the respective landing door.

A projection of the storage cavity onto a plane that is oriented parallel to the moving direction of the landing door provided at the respective landing may have a vertical dimension and a horizontal dimension. The horizontal dimension may be smaller than the vertical dimension. The opening of the storage cavity may in particular have a rectangular shape, with the long side of the rectangular shape oriented in a vertical direction. Such a configuration may provide a compact, space saving geometry for storing the mobile working platform.

The storage cavity may be accessible from outside the elevator car, in particular from the respective landing, providing convenient access to the mobile working platform.

The elevator system may further comprise a closing element, such as a flap or a door, for selectively closing the storage cavity. Such a closing element may protect the mobile working platform from adverse influences, such as dirt and/or moisture.

In order to prevent unauthorized access to and/or theft of the mobile working platform, the elevator system may further comprise a lock that allows selectively locking the closing element in a closed position.

The at least one storage cavity may be provided at any landing of the elevator system. An elevator system according to an exemplary embodiment of the invention may comprise a single storage cavity at one of the landings, or a plurality of storage cavities at different landings. At least one storage cavity may in particular be provided at the uppermost landing and/or at the lowermost landing of the elevator system.

In an embodiment, the elevator system further comprises a mobile working platform that fits into the storage cavity, in particular into a closed box provided in the storage cavity.

The mobile working platform may be convertible between a storage configuration in which it fits into the storage cavity and a deployed configuration in which it is set up in the elevator car.

The mobile working platform may in particular be foldable between the deployed configuration and the storage configuration.

The mobile working platform may comprise foldable or telescopic legs in order to allow for converting the mobile working platform between the storage configuration and the deployed configuration.

Exemplary embodiments of the invention further include a method of installing a mobile working platform in an elevator system comprising at least one storage cavity that is formed in a wall of the hoistway and/or in a landing door frame provided at the respective landing. The method includes taking the mobile working platform out of the storage cavity and installing the mobile working platform in the elevator car. The method may in particular include unfolding the mobile working platform before installing the mobile working platform in the elevator car.

Exemplary embodiments of the invention also include a method of deinstalling and storing a mobile working platform in an elevator system comprising at least one storage cavity that is formed in a wall of the hoistway and/or in a landing door frame provided at the respective landing. The method includes removing the mobile working platform from the elevator car and storing the mobile working platform in the storage cavity. The method may in particular include folding the mobile working platform before storing the mobile working platform in the storage cavity in order to reduce the space that is needed for storing the mobile working platform in the storage cavity.

The additional features, modifications and effects that have been described with respect to an elevator system according to exemplary embodiments of the invention analogously apply to the methods of installing and deinstalling a mobile working platform in an elevator system according to an exemplary embodiment of the invention.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts a schematic view of a landing door of an elevator system according to an exemplary embodiment of the invention.

FIG. 3A depicts a schematic sectional view through the hoistway of an elevator system according to an exemplary embodiment with a drawer that is arranged in a storage cavity.

FIG. 3B depicts a schematic sectional view through the hoistway of the elevator system depicted in FIG. 3A with the drawer being pulled out of the storage cavity.

FIG. 4 depicts a mobile working platform that is configured for being stored in the storage cavity of an elevator system according to an exemplary embodiment of the invention.

### DETAILED DESCRIPTION OF THE INVENTION

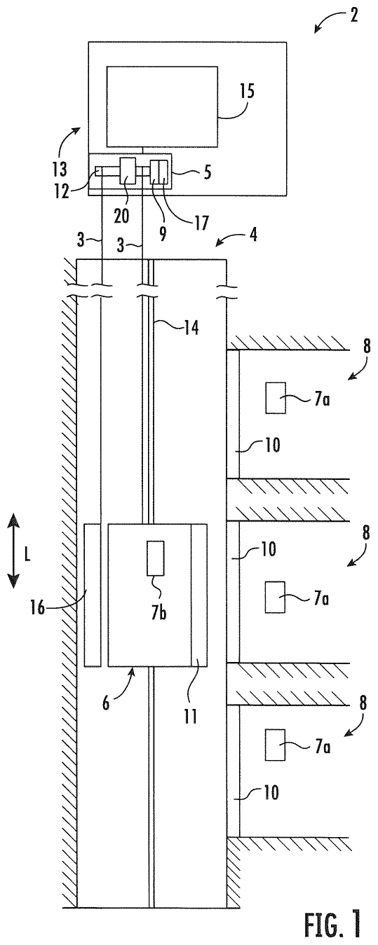

FIG. 1 schematically depicts an elevator system 2 according to an exemplary embodiment of the invention.

The elevator system 2 comprises a hoistway 4 extending in a longitudinal direction L between a plurality of landings 8 located on different floors. The elevator system 2 includes an elevator car 6 arranged in the hoistway 4 for being moved along the longitudinal direction L between the plurality of landings 8. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment not depicted in the figures the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3.

The tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the tension member 3, which is coupled to the shaft 12, in order to move the elevator car 6 in the hoistway 4 along the longitudinal direction L between the plurality of landings 8.

The elevator drive system 5 is further provided with at least one elevator brake 19 for braking rotation of the shaft 12 in order to allow for stopping movement of the elevator car 6.

The elevator system 2 may further include an elevator counterweight 16. The elevator counterweight 16 may be attached to the tension member 3 opposite to the elevator car 6 and configured for moving concurrently and in opposite direction with respect to the elevator car 6. The elevator counterweight 16 may move along at least one elevator counterweight guide member, which is not shown in FIG. 1.

Exemplary embodiments of the invention may be employed in elevator systems 2 comprising a counterweight and in elevator systems 2 that do not comprise an elevator counterweight.

The tension member 3 may be a rope, e.g. a steel cord, or a belt, in particular a coated steel belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person easily understands that the type of the roping is not essential for the invention and that different kinds of roping, e.g. a 2:1 roping or a 4:1 roping may be used as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2.

Alternatively, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be connected to the elevator controller 15 by means of electrical wiring not shown in FIG. 1, in particular by an electric bus, or by wireless data connections.

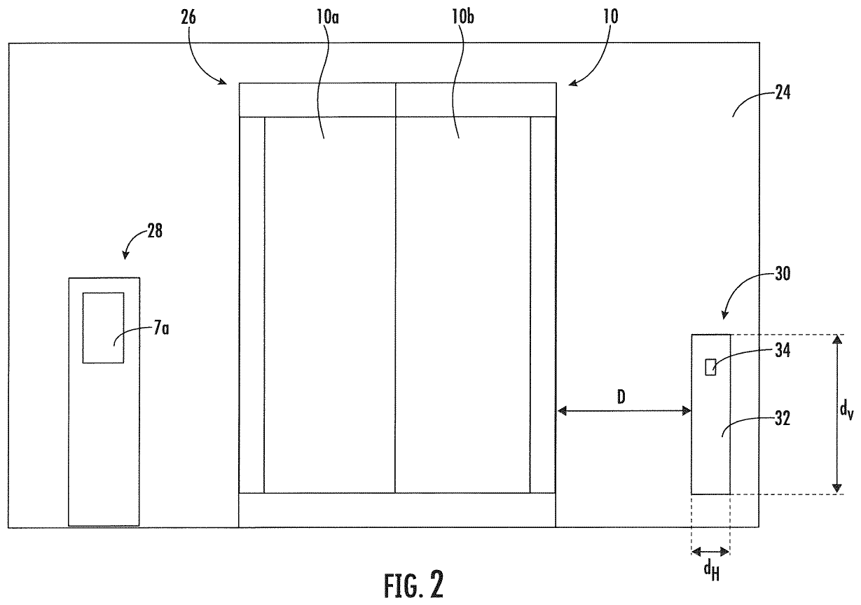

FIG. 2 depicts a schematic view of a landing door 10 and a storage cavity 30 provided adjacent to the landing door 10.

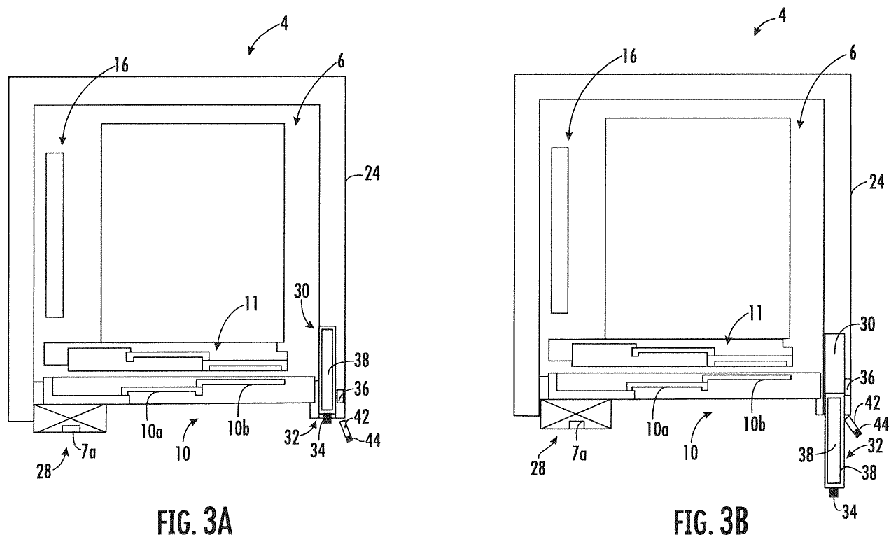

The landing door 10 is installed in an opening formed in a wall 24 of the hoistway 4 of the elevator system 2. In the embodiment depicted in FIG. 2, the landing door 10 comprises two landing door panels 10a, 10b that are mirror-symmetrically movable concurrently with each other for opening and closing the landing door 10. In an alternative embodiment, the landing door 10 may comprise two or more landing door panels 10a, 10b that are configured for concurrently moving into the same direction forming a telescopic landing door 10. Examples of telescopic landing doors 10 are depicted in FIGS. 3A and 3B, which will be discussed in more detail further below.

In yet another embodiment that is not explicitly depicted in the figures the landing door 10 may comprise only a single movable door panel 10a, 10b.

Each of the landing door panels 10a, 10b may be a single door panel 10a, 10b, as depicted in FIG. 2. In an alternative configuration, each of the landing door panels 10a, 10b may be a telescopic or central opening door panel 10a, 10b, respectively comprising a plurality of door panel elements that are movable with respect to each other for opening and closing the landing door 10.

The landing door panels 10a, 10b are framed by a landing door frame 26 surrounding the opening formed in the wall 24 of the hoistway 4.

A storage cavity 30 is formed in the wall 24 of the hoistway 4 adjacent to the landing door 10. The storage cavity 30 may be formed outside the landing door frame 26, as it is depicted in FIG. 2.

The storage cavity 30 may be formed in particular in a distance D of less than 3 m, in particular in a distance D of less than 2 m, more particularly in a distance D of less than 1 m from the landing door frame 26.

In an alternative configuration that is not explicitly shown in the figures, the storage cavity 30 may be formed in and/or extend through the landing door frame 26.

The storage cavity 30 is accessible from outside the elevator car 6, in particular from the respective landing 8.

A storage cavity 30 that is formed adjacent to the landing door 10 as depicted in FIG. 2 may be provided at any landing 8 of the elevator system 2. It is possible that an elevator system 2 according to an exemplary embodiment of the invention comprises a plurality of storage cavities 30 formed at different landings 8. A landing door 10 and a storage cavity 30 formed next to the landing door 10 may in particular be provided at the uppermost landing 8 and/or at the lowermost landing 8 of the elevator system 2.

The storage cavity 30 has an opening that is accessible from the landing 8. The opening has a vertical dimension dV and a horizontal dimension dH that is smaller than the vertical dimension dV. The opening of the storage cavity 30 has in particular a rectangular shape, with the long side of the rectangular shape oriented in the vertical direction and the short side of the rectangular shape oriented in the horizontal direction.

The horizontal dimension dH, may, for example, be in the range of between 0.2 m and 0.4 m; and the vertical dimension dV may, for example, be in the range of between 0.5 m and 1.0 m.

In an alternative configuration that is not explicitly shown in the figures, the storage cavity 30 may have a rectangular shape, with the long side of the rectangular shape oriented in the horizontal direction and with the short side of the rectangular shape oriented in the vertical direction. In other words, the rectangular opening of the storage cavity 30 may be rotated by 90° with respect to the configuration depicted in FIG. 2.

The elevator system 2 may further comprise a drawer 32 that is movable in and out of the at least one storage cavity 30. The drawer 32 may be equipped with at least one handle 34 that allows manually moving the drawer 32 in and out of the at least one storage cavity 30.

The drawer 32 may be slidably arranged in the storage cavity 30. Optionally, the drawer 32 may be supported by rollers (not shown) in the storage cavity 30 for reducing the friction between the drawer 32 and the walls of the storage cavity 30 when the drawer 32 is moved in and out of the storage cavity 30.

A landing control panel 7a is provided on the other side of the landing door 10. The landing control panel 7a may in particular be provided in a landing door cabinet 28 provided at the landing 8 adjacent to the landing door 10.

FIGS. 3A and 3B depict schematic horizontal sectional views through the hoistway 4 of an elevator system 2 according to an exemplary embodiment of the invention at one of the landings 8.

FIGS. 3A and 3B respectively show an elevator car 6 with an elevator car door 11 within the hoistway 4.

An elevator counterweight 16 that is configured for moving concurrently and in opposite direction with respect to the elevator car 6 is depicted next to the elevator car 6.

FIGS. 3A and 3B further depict a landing door 10, and a landing control panel 7a provided in a landing door cabinet 28 next to the landing door 10.

A storage cavity 30 is formed in the wall 24 of the hoistway 4 depicted on the right side of the landing door 10 in FIGS. 3A and 3B. In alternative embodiments, the storage cavity 30 may be formed on the left side of the landing door 10 or in the landing door cabinet 28.

A drawer 32 is provided in the storage cavity 30 such as to be movable in and out of the at least one storage cavity 30.

In the configuration depicted in FIG. 3A, the drawer 32 is arranged in the storage cavity 30. In the configuration depicted in FIG. 3B, the drawer 32 has been pulled out of the storage cavity 30 so that a substantial portion of the drawer 32 is arranged outside the storage cavity 30.

As mentioned with respect to FIG. 2, the drawer 32 is equipped with at least one handle 34 in order to allow for moving the drawer 32 manually in and out of the storage cavity 30.

Alternatively or additionally, the elevator system 2 may comprise a motor 36 that is configured for moving the drawer 32 in and out of the storage cavity 30.

The drawer 32 may be made of metal and/or of a synthetic material.

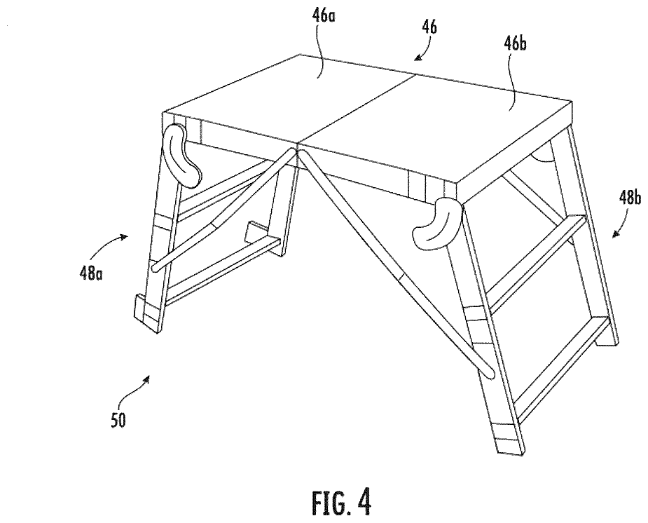

A closable box 38 for accommodating a mobile working platform 50 (see FIG. 4) may be provided in the drawer 32. The at least one closable box 38 may, for example, be made of metal and/or of a synthetic material.

Storing the mobile working platform 50 in a closable box 38 provided in the drawer 32 may protect the mobile working platform 50 from adverse external influences, such as dirt and/or moisture. It may further prevent the mobile working platform 50 from getting caught when moved in and out of the at least one storage cavity 30.

In the embodiment depicted in FIGS. 3A and 3B, the drawer 32 is movable in a vertical plane that is oriented perpendicularly to the moving direction of the landing door panels 10a, 10b.

In an alternative embodiment that is not explicitly depicted in the figures, the drawer 32 may be movable in a direction that is oriented parallel to the moving direction of the landing door 10.

In yet another embodiment, the drawer 32 may be pivotable around an axis that may extend horizontally or vertically.

Optionally, the elevator system 2 may comprise a closing element 42, such as a flap or a door, for selectively closing the storage cavity 30. The closing element 42 may be pivotable around an axis that may be oriented in a vertical direction or in a horizontal direction. Alternatively, the closing element 42 may be slidable in the vertical direction or in the horizontal direction providing a sliding door. In yet another embodiment, the closing element 42 may include a roller shutter.

The closing element 42 may be equipped with a lock 44 that allows for selectively locking the closing element 42 in its closed position for preventing unauthorized access to and/or theft of a mobile working platform 50 stored in the storage cavity 30.

FIG. 4 depicts an exemplary embodiment of a mobile working platform 50 that is configured for being stored in the storage cavity 30.

The mobile working platform 50 comprises a support panel 46 for supporting a person and allowing the person to access components located on top of the elevator car 6 or in the hoistway 4 above the elevator car 6.

The mobile working platform 50 further comprises at least two legs 48a, 48b for supporting the support panel 46. The at least two legs 48a, 48b may be configured for supporting the support panel 46 on a floor of the elevator car 6.

The at least two legs 48a, 48b may also be configured for supporting the support panel 46 on dedicated supports or handrails provided in the elevator car 6. Such an embodiment of a working platform 50 is, for example, described in the European patent application EP 3 702 309 A1 filed by the applicant.

The mobile working platform 50 is convertible between a storage configuration and a deployed configuration. In the storage configuration, the mobile working platform 50 fits into the storage cavity. In the deployed configuration, the mobile working platform 50 is configured for being installed in the elevator car 6 and for supporting a person on the support panel 46. In FIG. 4, the mobile working platform 50 is depicted in the deployed configuration.

The mobile working platform 50 may be foldable between the deployed configuration and the storage configuration.

In order to allow for folding the mobile working platform 50, the support panel 46 may comprise at least two support panel elements 46a, 46b that are movable, in particular pivotable or foldable, with respect to each other.

Alternatively or additionally, the legs 48a, 48b of the the mobile working platform 50 may be pivotable with respect to the support panel 46.

The legs 48a, 48b may be foldable legs 48a, 48b or telescopic legs 48a, 48b that allow for modifying the lengths of the legs 48a, 48b for reducing the dimensions of the working platform 50 in order to allow for storing the working platform 50 in the storage cavity 30, in particular in a closable box 38 located in the storage cavity 30.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator system (2) comprising a hoistway (4) extending between a plurality of landings (8) and an elevator car (6) that is movable in the hoistway (4) between the plurality of landings (8); wherein the elevator system (2) further comprises:
landing doors (10) provided at the landings (8); and
at least one storage cavity (30) provided at at least one of the landings (8) for accommodating a mobile working platform (50) that is configured for being set up in the elevator car (6);
wherein the at least one storage cavity (30) is formed in a wall (24) of the hoistway (4) and/or in a landing door frame (26) provided at the respective landing (8).

2. Elevator system (2) according to claim 1, further comprising at least one drawer (32) that is movable in and out of the at least one storage cavity (30), wherein the at least one drawer (32) is in particular linearly movable.

3. Elevator system (2) according to claim 2, wherein the at least one drawer (32) is made of metal and/or of a synthetic material.

4. Elevator system (2) according to claim 2, wherein the at least one drawer (32) comprises at least one closable box (38) for accommodating the mobile working platform (50), wherein the at least one closable box (38) is in particular made of metal and/or of a synthetic material.

5. Elevator system (2) according to claim 2, wherein the at least one drawer (32) is manually movable in and out of the at least one storage cavity (30).

6. Elevator system (2) according to claim 2, further comprising a motor (36) for moving the drawer (32) in and out of the at least one storage cavity (30) by operating the motor (36).

7. Elevator system (2) according to claim 2,
wherein the drawer (32) is movable in a plane that is oriented perpendicularly to the moving direction of the landing doors (10) provided at the respective landing (8), or
wherein the drawer (32) is movable in a plane that is oriented parallel to the moving direction of the landing doors (10) provided at the respective landing (8).

8. Elevator system (2) according to claim 1, wherein the storage cavity (30) is accessible from outside the elevator car (6), in particular from the respective landing (8).

9. Elevator system (2) according to claim 1, wherein a projection of the storage cavity (30) onto a plane that is oriented parallel to the moving direction of the landing doors (10) provided at the respective landing (8) has a vertical dimension dV and a horizontal dimension dH that is smaller than the vertical dimension dV.

10. Elevator system (2) according to claim 1, comprising a closing element (42), such as a flap or a door, for selectively closing the storage cavity (30), wherein the elevator system (2) comprises in particular a lock (44) for selectively locking the closing element (42) in a closed position.

11. Elevator system (2) according to claim 1,
wherein a storage cavity (30) is provided at the uppermost landing (8) of the plurality of landings (8) and/or
wherein a storage cavity (30) is provided at the lowermost landing (8) of the plurality of landings (8).

12. Elevator system (2) according to claim 1 further comprising a mobile working platform (50) that fits into the storage cavity (30).

13. Elevator system (2) according to claim 12, wherein the mobile working platform (50) is convertible between a storage configuration in which it fits into the storage cavity (30) and a deployed configuration in which it is configured for being installed in the elevator car (6); wherein the mobile working platform (50) is in particular foldable into the storage configuration and/or wherein the mobile working platform (50) comprises foldable or telescopic legs in order to allow for converting the mobile working platform (50) between the storage configuration and the deployed configuration.

14. Method of installing a mobile working platform (50) in an elevator system (2) according to claim 12, wherein the method includes:
taking the mobile working platform (50) out of the storage cavity (30); and
installing the mobile working platform (50) in the elevator car (6);
wherein the method in particular includes unfolding the mobile working platform (50) before installing the mobile working platform (50) in the elevator car (6).

15. Method of deinstalling and storing a mobile working platform (50) in an elevator system (2) according to claim 12, wherein the method includes:
removing the mobile working platform (50) from the elevator car (6);
storing the mobile working platform (50) in the storage cavity (30);
wherein the method in particular includes folding the mobile working platform (50) before storing the mobile working platform (50) in the storage cavity (30).
